(19) United States
(12) Patent Application Publication
(10) Pub. No.: US 2026/0296594 A1
(43) Pub. Date: Oct. 1, 2026

(54) BICYCLE DRIVETRAIN MANAGEMENT AND REAR SUSPENSION

(71) Applicant: Telepathy Bikes, LLC, Bozeman, MT (US)

(72) Inventor: Matthew Walter Lessmeier, Bozeman, MT (US)

(21) Appl. No.: 19/630,193

(22) Filed: Mar. 26, 2026

Related U.S. Application Data
(60) Provisional application No. 63/781,888, filed on Apr. 1, 2025.

(51) Int. Cl. B62M 9/16; B62K 3/02; B62K 25/28

(52) U.S. Cl. CPC B62M 9/16; B62K 3/02; B62K 25/28

(57) ABSTRACT

A mountain bike linkage system allowing for a structurally efficient layout of pivots and allowing for integration with a drivetrain management system that nearly eliminates chain growth.

### TECHNICAL FIELD

The present disclosure is directed toward managing drivetrain effects of rear wheel suspension linkages for mountain bikes.

### BACKGROUND

Mountain bikes are designed to withstand and maneuver uneven terrain without compromising traction, stability, and control. To do this, suspension linkages are implemented to allow the rear wheel to track uneven terrain, and to decouple the movement of the wheel with movement of the rider.

Such a linkage is disclosed in Leitner US 5,899,480. Such linkages suffer from chain growth. In reality, the chain does not change length, but the rear derailleur cage extends to spool out more free chain length. Chain growth here means the change in chain length that would be needed were this not to happen. When the rear wheel moves, the distance between the chainring and the cassette can change When the distance increases, the rear derailleur cage needs to extend and spool out additional free chain. In extreme cases, the rear derailer cage cannot accommodate the chain as there is too much chain growth thereby limiting the amount of rear travel realistically achievable with a standard rear derailleur.

This is true of bikes using conventional vertical axle paths, but more so for rearward axle paths, such as the parallel axle path where the rear axle moves parallel to the front axle. With rearward axle path bikes, not only does the wheel move up , it also moves back, meaning that the distance between cassette and chainring increases even more than on standard vertical axle path bikes. The rearward axle path can limit the amount of rear travel that is achievable because the chain growth can quickly get to be too much for the rear derailleur to handle. For parallel axle path bikes, and rearward axle path bikes in general to become practical, this problem needs to be solved.

The problem goes beyond limiting the travel. The derailleur cage has a clutch mechanism that acts as a parasitic friction force on the linkage. This is also true of any other tensioning element. The friction force limits the small bump sensitivity of suspension linkages since it resists suspension motion. Yet, the friction force is needed to retain the chain as the bike encounters bumps, and also to limit the chain slapping against frame members. Chain slap is undesirable because it can cause unpleasant noise, but more importantly because the chain can fall off if it vibrates too far from its equilibrium position for the chainring to continue retaining it.

This derailleur clutch/ tensioning element limiting small bump sensitivity is a problem on every bike with chain growth.

On the contrary, if the chain is removed, the rear suspension is much more active over small bumps, resulting in a smoother ride. This is evidence of the need to control chain growth in suspension linkage design.

A related problem is pedal kickback, which occurs when the chain rotates backward as a result of suspension articulation. This causes the chain to pull on the chainring and rotate it backward, causing the pedals to ‘kick’ up into the rider’s feet if the rear wheel angular velocity is not sufficient to compensate the rotation before it occurs in the drivetrain. The rider feels this as a harsh impact to the feet when the bike is moving slowly and encounters a big impact.

A lower idler pulley is one solution to limit chain growth in bikes having a rearward axle path. The lower idler pulley or roller is in contact with a lower chain run, which is a portion of the chain that is not under drive tension. The placement does not affect the pedal kickback, which can be optimized independently with the upper idler pulley. The upper idler pulley is an idler gear that is used to route the tensioned portion of the chain in a desired way. It is typically free to rotate in both directions.

Lower idlers are commonly mounted to the International Standard Chain Guide (ISCG) tabs, which are standardized mounting plates rigidly connected to the bottom bracket of the front main frame. However, this limits design freedom due to the lower idler pulley being fixed relative to the front main frame and not moveable as the suspension compresses.

In some rear wheel suspension bikes, the idler wheel or pulley is located high on the rear triangle, resulting in lower chain wrap around the rear cassette than is desirable. This leads to the chain slipping along the gears when under high motive load and when in the smaller gears on the cassette.

Some high pivot linkage designs also require the physical pivots to be located high on the frame, allowing for a large moment or torque from the lateral ground load when cornering, resulting in more laterally flexible components than desirable.

### SUMMARY

The present disclosure includes a lower idler pulley mounted on a frame member that is movable relative to the front main frame, and that is not the only moveable member. This way the motion path of the lower idler spools out the chain instead of relying on the rear derailleur with its parasitic clutch to do so. This is not possible with a fixed mounting location on the front main frame as is currently used with the ISCG tabs.

The present disclosure also includes a new layout with optimal linkage configuration to allow for a lower, upper idler mounting location and laterally stiffer support locations for mountain bikes with the Parallel Axle Path. The lower, upper idler mounting location is important to stop the chain from skipping across the cassette due to lack of engagement. The linkage system includes a top link that is connected at its top to the front main frame, and at its bottom to the swingarm. This allows for a significantly wider distance between supports with respect to the vertical dimension, which improves structural efficiency. This linkage system also allows for an upper idler mounting location on the rear triangle which remains at a nearly constant distance from the chainring, to minimize chain growth and pedal kickback. This linkage shifts the pedal kickback into negative angles, which means that the freehub of the rear cassette can rotate to compensate and no rotation is transferred to the cranks. This results in no real pedal kickback experienced by the rider. The idler can however be mounted to any of the frame members and need not be limited to the rear triangle.

In at least one embodiment, at least one of the physical pivots is lowered to decrease the moment arm from the lateral ground loading at the tire contact patch, as well as to spread apart the two front main frame pivots in both in plane dimensions so as to improve the structural efficiency.

### BRIEF DESCRIPTION OF THE DRAWINGS

FIG. 1A is a perspective view of a bicycle with a rear suspension linkage system according to an embodiment and that has its rear shock in the fully extended configuration.

FIG. 1B is a close-up view of the motion paths of the upper and lower idlers of FIG. 1A.

FIG. 1C is a perspective view of the bicycle with rear suspension fully compressed.

FIG. 2A is a perspective view of a bicycle with a rear suspension linkage system according to another embodiment.

FIG. 2B is a top view of a rear swingarm of the linkage system of FIG. 2A.

FIG. 2C is a top view of a bottom link of the linkage system of FIG. 2A.

FIG. 2D is a top view of a top link of the linkage system of FIG. 2A.

FIG. 3 is a close-up view of the linkage of another embodiment with the lower idler mounted on a different movable member.

FIG. 4 is a graph of the motion path of the lower idler according to two embodiments.

FIG. 5 is a perspective view of a known solution using a single pivot linkage and ISCG mounted lower idler.

FIG. 6 is a close-up of a known solution using a lower idler mounted to the ISCG tabs of the front main frame.

### DETAILED DESCRIPTION

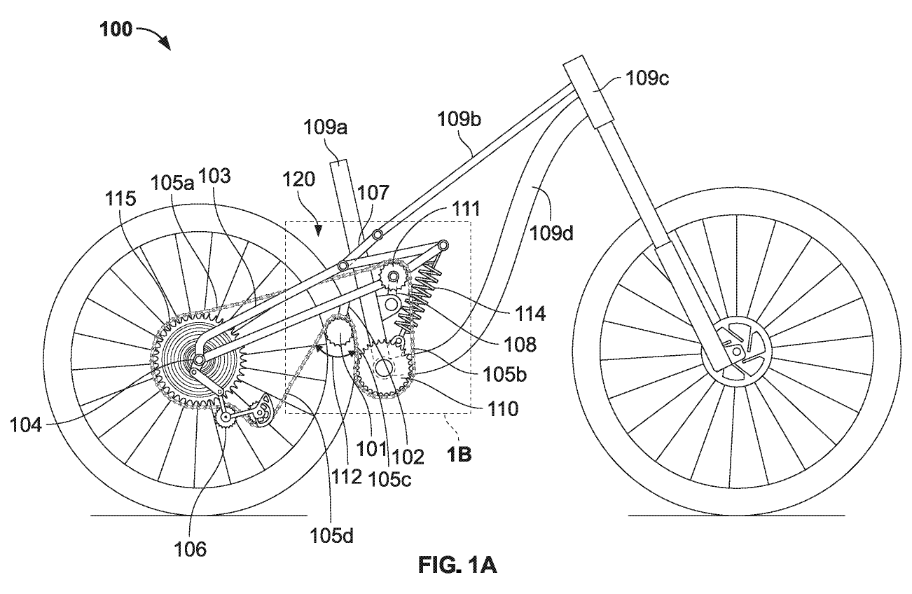

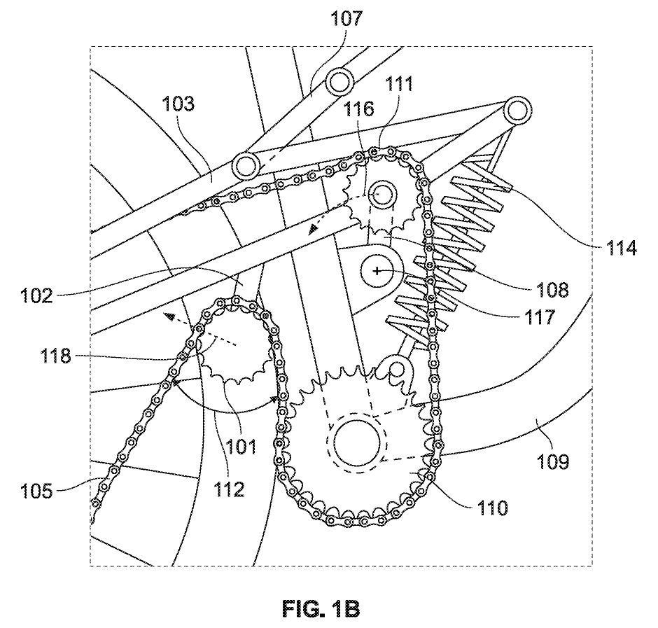

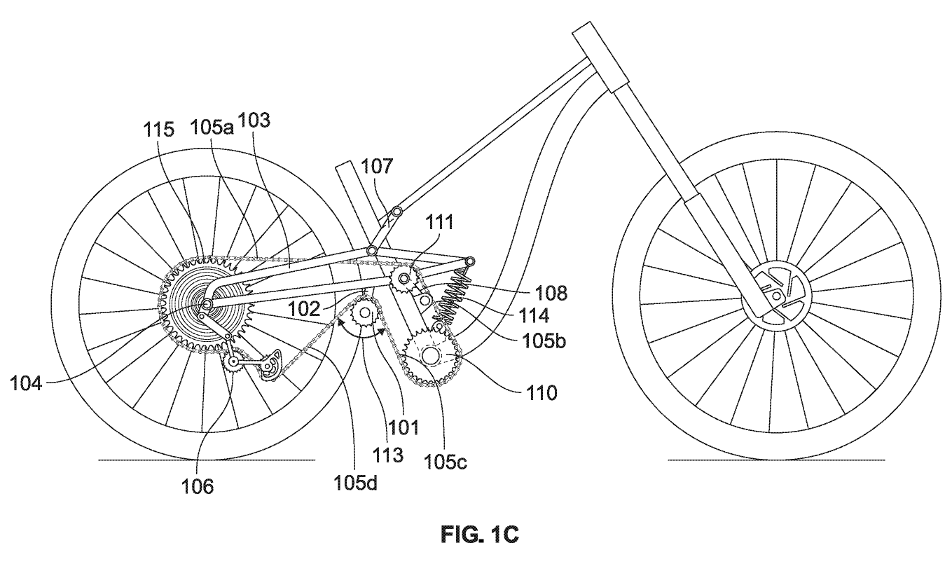

All of the references to direction described herein should be interpreted with respect to a bicycle standing up straight with its wheels planted on a flat horizontal surface, with the fork as the front, and with the suspension fully extended (zero sag) except when explicitly mentioned (i.e. the rear suspension is fully compressed in FIG. 1C). The vertical plane is the plane of the longer dimensions of the bicycle. References to down, bottom, lower, and similar refer to the direction toward the ground as the bike is standing up normally on such a flat horizontal surface. Front is toward the direction the bicycle is normally ridden in.

FIG. 1A is a bicycle 100 with a rear suspension linkage system 120 that is fully extended and a drivetrain management system. The bicycle 100 includes a swingarm 103 coupled to a main frame 109, the rear suspension linkage system 120, the drivetrain management system, a rear axle 104, and a shock 114. The drivetrain management system includes an upper idler 111, a lower idler 101, and a derailleur cage 106 that guides a chain 105 as it moves across a cassette 115.

In this embodiment, the main frame 109 of the bicycle 100 includes a seat support portion 109a coupled to a front wheel support portion 109c via an upper connecting portion 109b and a lower connecting portion 109d. The upper connecting portion 109b is closer to the user or rider when using the bicycle than the lower connecting portion 109d which is closer to the ground than the upper connecting portion 109b. In other embodiments, the main frame 109 configuration is not limited to the illustrated arrangement and may be adapted for different bicycle designs.

The linkage system 120 includes the top and bottom links 107, 108 coupling the swingarm 103 to the main frame 109. The linkage system 120 further includes the upper idler system having an upper idler pulley, guide, or wheel 111 coupled to the frame 109 via the bottom link 108.

In this embodiment, the bottom link 108 is directly coupled to a front side of the seat support portion of the frame 109a via a pivotal connection, between the upper connecting portion 109b and the lower connecting portion 109d. In other words, the bottom link 108 is coupled closer to the seat support portion 109a of the frame than the front wheel support portion 109c of the frame. In other embodiments, the connection point is elsewhere on the main frame 109. The upper idler 111 is moveable relative to the main frame 109 as the suspension compresses via its fixing point to the swingarm 103, lower idler arm, 102, and/or bottom link 108. The upper idler 111 could also be mounted elsewhere in other embodiments.

The lower idler system includes a lower idler pulley, guide, or wheel 101 that is mounted or coupled on an lower idler arm 102 that is a part of, or rigidly connected to, the swingarm 103.

The drivetrain management system further includes the upper or drive force tensioned idler 111 and lower idler 101 positioned in particular useful relations to the rest of the linkage members, which could be those of the linkage system 120 of any other system. The upper 111, and lower 101 idlers can also be used independently.

The drivetrain management system can be visualized in an easy way by imagining the chain starting in a ‘V’ shape, and as the suspension articulates to full compression, the V extends into a straight line ‘___’. Thus, the distance between the chainring and the cassette (the top points of the ‘V’) may still increase, but the chain need not grow beyond what the opening of the ‘V’ can accommodate. This will limit the need for the rear derailleur cage to extend because the chain is effectively spooled out by the lower idler itself. This is accompanied by no, or very little parasitic friction, giving much better small bump performance to the suspension system.

In FIG. 1A the location of the lower idler 101 is chosen so that it moves backward, following the rear axle 104 as the suspension compresses, so as to open the ‘V’ and spool out the chain 105 that would otherwise cause the derailleur cage 106 to extend.

The chain 105 is composed of the upper rear portion, 105a, upper front portion, 105b, lower front portion, 105c, and lower rear portion, 105d. The upper rear portion, 105a runs from the cassette, 115 to the upper idler, 111. The upper front portion, 105b runs from the upper idler, 111 to the chainring, 110. The lower front portion, 105c runs from the chainring, 110 to the lower idler, 101. The lower rear portion, 105d runs from the lower idler, 101 to the cassette, 115.

The chain growth referred to here is that defined by the change in path lengths of 105a, 105b, 105c, and 105d if the derailleur cage was not to extend or retract as the rear suspension compresses.

In some embodiments, the linkage 120 includes a plurality of rigid members or portions that are pivotally connected, provided that the swingarm 103 is not directly pivotally connected to the main frame 109 as on single pivot designs. In some embodiments, the linkage 120 has no true swingarm.

According to at least one embodiment, a dual link suspension linkage 120 has two links, a top link 107 and a bottom link 108, pivotally connecting the swingarm, 103 to the main frame, 109. The shock, 114 is shown connected between the swingarm, 103 and main frame, 109 but may be connected between any linkage members according to this disclosure. The lower idler, 101 may be connected to any member that moves relative to the main frame, 109. In one embodiment, it moves up and backward to spool out the chain. It may also move downward to spool out the chain. In yet another, it moves closer to the chainring, 110 to shorten a portion of the chain, 105 to compensate for lengthening of any of the other portions. Similarly, it could move closer to the rear axle, 104.

The lower idler, 101 may be a true gear or a roller as it is not under any drive tension. It may move backward, to follow the axle and maintain the lower idler to axle distance as constant, or nearly constant. In at least one embodiment, the lower idler, 101 is fixed to the swingarm, 103, so the lower idler, 101 to cassette, 115 distance is constant. The lower idler, 101 moves up and back along its motion path, 118 as shown in FIG. 1B.

With proper mounting of the upper idler, 111 such that it moves approximately in a portion of a circle concentric with the chainring, this configuration can provide for a total chain growth of less than (plus or minus) 5 mm. The upper idler motion path 116 and the lower idler motion path 118 are shown in FIG. 1B. While the combination of engineered motion paths of both upper and lower idlers provide the best results, they are not always necessary together. Both the upper and lower idler motion paths, 116 and 118 can be used independently. The motion paths can take on other shapes and directions in order to allow the designer to achieve the desired effect, usually changing the length of a portion of the chain as the rear suspension compresses.

In one embodiment, the curvature of the upper idler motion path, 116 will have the same sign as the curvature of the chainring, 110 when the chainring center is taken as the origin. In preferred embodiments, the radius of this motion will be within 100 mm of the pitch radius of the chainring, or more preferably 50 mm, and most preferably 25 mm throughout the travel. Less than 10mm is achievable, but is not always necessary. The instant center of the upper idler motion path, 117 to chainring center, 110 distance will not be more than 250 mm, or more preferably 200 mm, and most preferably 150 mm. Less than 130 mm is achievable but not always necessary. The instant center of the upper idler motion path, 117 is simply the pivot here, as it is mounted on a link fixed to the main frame. This need not be the case and is only one preferred embodiment. All other components of FIG. 1B are the same as FIG. 1A.

In another embodiment, the distance between the upper idler center and the chainring center changes by a distance of less than plus or minus 100 mm, more preferably plus or minus 50 mm, and most preferably plus 20 mm and minus 30 mm.

In another embodiment, the distance between the upper idler center and the rear axle center changes by a distance of less than plus or minus 100 mm, more preferably plus or minus 50 mm, and most preferably plus 20 mm and minus 30 mm.

In yet another embodiment, both the upper idler to rear axle, and the upper idler to chainring center distances change by less than plus or minus 100 mm, more preferably plus or minus 50 mm, and most preferably plus 20 mm and minus 30 mm.

By mounting the upper idler on a member moveable relative to the main frame, 109, and by engineering the motion path, the upper idler, 111 to chainring, 110 distance can remain approximately constant or even decrease. The combination of the motion path of the upper idler, 111 and lower idler, 101 is what allows for low chain growth. This is compared to a standard, vertical axle path chain growth of ~ 55 mm, or a rearward axle path chain growth of ~ 60-100 mm. In contemplated embodiments of this disclosure the total chain growth is preferably between -40 to 30 mm, or more preferably, -30 to 20 mm, and most preferably -20 to 10 mm . An embodiment similar to that shown in the figures is capable of less than plus or minus 5 mm throughout the travel on 150-170 mm (vertical) travel designs having between 60 mm and 85 mm of horizontal rear wheel travel. This chain growth limiting effect is particularly important on bikes having greater than 10 mm of rearward travel at the rear wheel, or more important for those with greater than 30 mm, and most important for those with greater than 50 mm.

The chain may actually shorten with certain embodiments, the upper chain run in particular may shorten. This is okay as the freehub will rotate to compensate and is not associated with any significant parasitic friction.

FIG. 1C is the same bicycle as FIG. 1A, but with suspension fully compressed. The lower idler, 101 has moved backward, following the rear axle, 104. It has spooled out its chain as is evidenced by the lower idler chain wrap angle, 112 in FIG. 1A being less than the same angle, 113 in FIG. 1C. In preferred embodiments, the change in this angle while in the smallest gear on the cassette is more than 10 degrees, more preferably more than 20 degrees, and most preferably more than 30 degrees. About 40 degrees is practically achievable. These dimensions all refer to drivetrains using a chain length that is set up as recommended by the manufacturer. Notice how the derailleur cage, 106 remains at the same approximate extension between FIGS. 1A and 1C. This is the goal.

FIG. 1C shows one example embodiment, but the lower idler may be mounted in any manner so as to move in a way which controls the chain growth, as long as it moves with respect to the main frame during suspension compression, and provided that it is not mounted on the swingarm of a single pivot. Mounting to the swingarm of a single pivot limits the design freedom, and also limits other kinematic variables such as the axle path and practical variables such as the lateral frame stiffness to an unacceptable degree. The other components of FIG. 1C are the same as in FIG. 1A.

The present disclosure includes (1) mounting the lower idler on a moveable point and (2) a motion path of a lower idler that controls total chain growth. This disclosure is distinct from mounting lower idlers on the swingarms of single pivots.

Change in angle is more specific. This disclosure is to mount the lower idler to the swingarm and use a multi-pivot linkage, thereby significantly improving chain growth. In some embodiments, the lower idler mount and multi-pivot linkage is capable of achieving chain growth ranging from X mm to Y mm (see paragraph 0046). In at least one embodiment, the chain growth is 4 mm. In other embodiments, the lower idler could be mounted on the link of a multi-link suspension system. Other solutions have used the lower idler as a chain tensioner, that is, it is spring loaded. The present dislcosure is not spring loaded and instead relies on the rear derailleur for the chain tensioning function. Making the lower idlers motion spring loaded would counter the goal since it would add back the undesired parasitic friction.

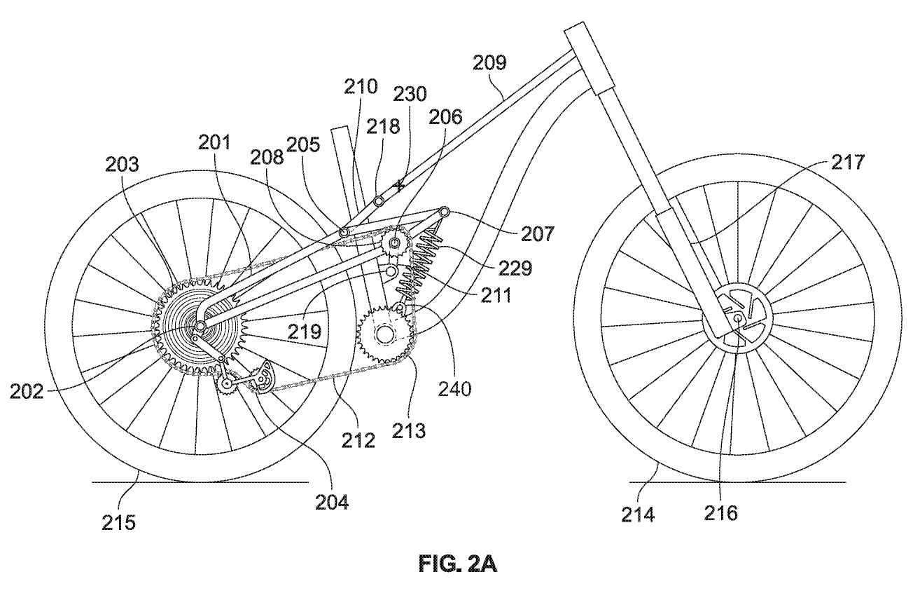

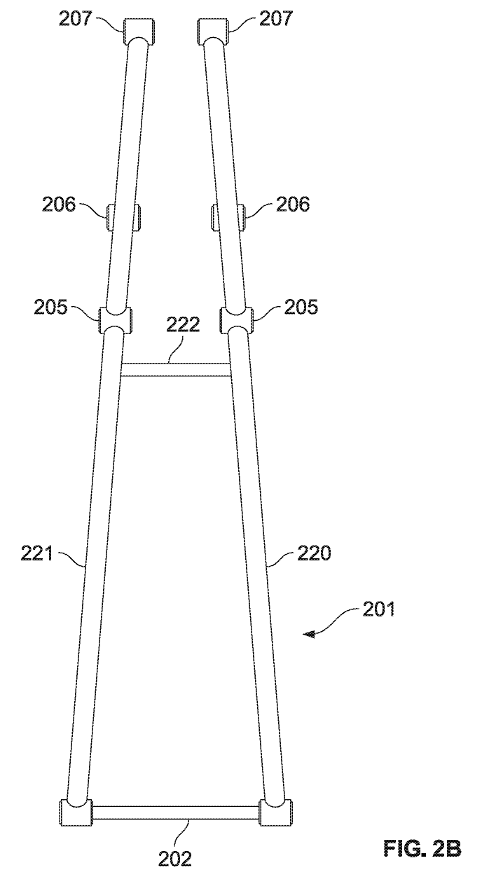

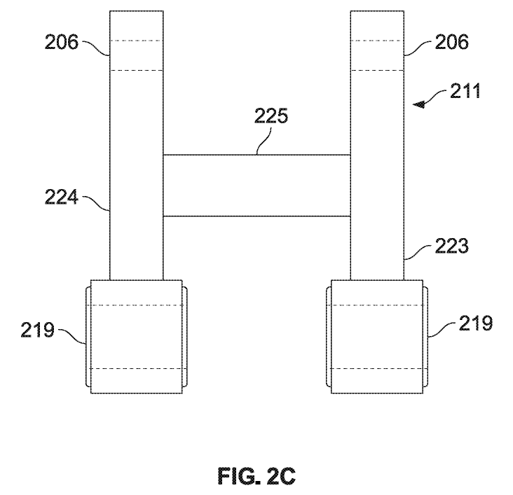

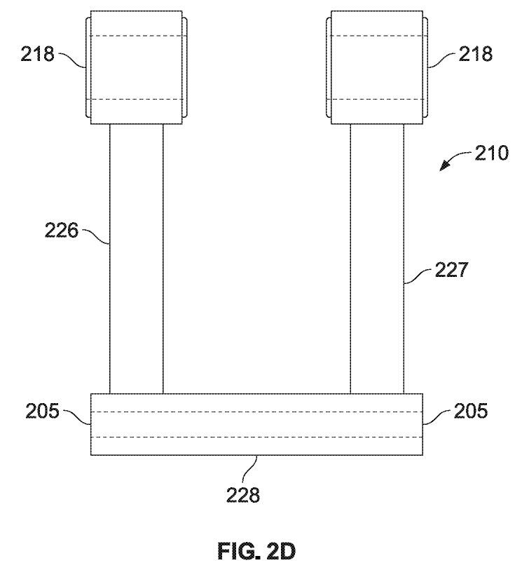

FIG. 2A shows a side view of the bicycle using a linkage according to another embodiment. Except as otherwise described herein, the bicycle includes the same features as those illustrated and described with respect to FIGS. 1A-1C.

The swingarm, 201 is connected to the rear axle, 202, which also houses the cassette, 203. In reality, the cassette may have any numbers of cogs or gears. The rear derailleur, 204 is connected to the rear triangle and/or rear axle at or near the rear axle’s mounting location on the rear triangle. It is represented schematically by two circles representing two pulley wheels on the derailleur cage. The disclosure may use any type, or no rear derailleur mechanism having any number, or no pulley wheels.

The rear swingarm, 201 is a rigid member connecting the rear axle 202 via the top swingarm pivot or pivotal connection, 205, the bottom swingarm pivot or pivotal connection, 206, and the swingarm shock mount, 207. The swingarm pivots 205, 206, main frame pivots 218, 219, the swingarm shock mount 207, and the main frame shock mount 240 are all pivotal connections that allow rotation between the coupled members using bearings, bushings, flexible members, or other means known in the art that allow relative rotation of two members.

The main frame shock mount 240 is preferably within 200 mm, more preferably 150 mm, and most preferably 100 mm of the chainring center 213.

The upper idler system includes an upper idler wheel 208 connected to the swingarm 201 at the lower swingarm pivot 206. This is one optimal location but it may also be located anywhere on the swingarm 201, the front main frame, 209, the top link, 210, and/or the bottom link, 211, or any additional member that may be added for the purpose.

The chain, 212 is routed between the cassette, 203 and the front chainring, 213 and passes over the upper idler wheel 208. The upper idler is further defined as being under chain tension from the drive force. A lower idler may also be used to limit chain growth, where it will be used on the lower part of chain run that is not under drive tension.

The bicycle 200 also has other components including front wheel, 214 and rear wheel, 215. The rear wheel is connected to the swingarm, 201 via the rear axle, 202. The front wheel is connected to a front axle, 216 which is connected to a front fork, 217.

The top link, 210 is pivotally connected between the upper swingarm pivot, 205 and the main frame upper pivot or pivotal connection, 218. The main frame upper pivot, 218 is above and to the front of the upper swingarm pivot, 205. In one embodiment, it is between 0-200 mm above and 0 - 200 mm in front, or more preferably 15 - 150 mm above and 15 – 150 mm in front, or most preferably 25 - 100mm above 25 and 125 mm in front.

The bottom link, 211 is pivotally connected between the lower swingarm pivot, 206 and the lower main frame pivot or pivotal connection, 219. The lower swingarm pivot, 206 is above the lower main frame pivot, 219. In one preferable embodiment it is between 0 and 200 mm above, more preferably 15 and 140 mm above, or most preferably 25 and 90 mm above.

The instant center of the rear axle, 230 is denoted with a ‘+’ sign and marks the instantaneous center of rotation. It is found by the intersection of the line running through the upper swingarm pivot, 205 and upper main frame pivot, 218 with the line running through the lower main frame pivot, 219 and the lower swingarm pivot, 206. When these lines are extended, they meet at the instant center. This is true for all points in the bicycle’s travel, but the instant center shown is at zero compression. One goal of this disclosure is to keep the instant center high, to achieve the desired wheel path, while mounting the upper idler wheel 208 at a lower location to provide for better chain wrap on the cassette, 203. This prevents the chain from skipping over the gears of the cassette.

The upper swingarm pivot, 205 is above the lower swingarm pivot, 206. In one preferable embodiment, it is between 0 – 250 mm above, more preferably 0 - 150 mm, and most preferably 0- 80 mm above.

In one preferable embodiment, the lower swingarm pivot, 206 is in front of the upper swingarm pivot, 205. It can be between 0 – 250 mm in front, more preferably 0 – 150 mm in front, or most preferably 0 – 100 mm in front. Above/ below refer to the vertical dimension, where in front refers to the horizontal dimension.

The shock, 229 is connected between the swingarm, 201 and main frame, 209. In one embodiment, the swingarm shock mount, 207 is in front of both the upper swingarm pivot, 205 and the lower swingarm pivot, 206. In one embodiment, it is preferably between 0 – 350 mm in front, more preferably 50 – 250 mm in front, and most preferably 100 - 150 mm in front of the lower swingarm pivot, 206. It is preferably between 0 – 450 mm in front, more preferably 50 – 350 mm in front, and most preferably 100 - 260 mm in front of the upper swingarm pivot, 205. This is only one embodiment, the shock, 229 may be connected between any of the members shown, or additional members not shown such as a rocker link (member with pivotal connections to (1) another linkage member, (2) the front main frame, and (3) the shock) or an additional linkage driving the shock. Such linkage will be deemed a shock linkage if it does not modify the wheel path (shape) other than in amount of travel achievable with a given shock stroke of the linkage described above by its inclusion. These other shock mounting methods are all used to achieve the desired leverage. An independent shock linkage can be used to tune the leverage independently of the wheel path and other kinematic variables.

FIG. 2B shows the swingarm, 201 from a top view to illustrate that it may have two halves or portions, 220 and 221 that are connected by a bridge member, 222. These two halves 220, 221 will be symmetric with respect to the pivotal connections 205,206, swingarm shock mount, 207 and rear axle, 202 locations in the vertical plane. However, they may be asymmetric or differ in other regards between the two halves 220 and 221. This bridge member may be present, more than one may be present, or there may be no bridge member and the halves are simply connected through the pivotal connection(s) 205 and/or 206.

FIG. 2C shows the bottom link, 211 from a top view to illustrate that it may have two halves or portions, 223 and 224. They will be symmetric with respect to the lower swingarm pivot 206 and the lower main frame pivot 219 locations in the vertical plane, but may be different or asymmetric in other regards between the two halves 223 and 224. The two halves, 223 and 224 are connected by a bridge member 225. This bridge member may be present, more than one may be present, or there may be no bridge member and the halves are simply connected through the pivotal connection(s), 206 and/or 219.

FIG. 2D shows the top link, 210 that pivotally connects the upper swingarm pivot, 205 with the top main frame pivot, 218. The top link may have two halves or portions, 226 and 227. They will likewise be symmetric with respect to the upper swingarm pivot, 205 and the upper main frame pivot, 218 locations in the vertical plane, but may be different or asymmetric in other regards between the two halves, 226 and 227. The two halves, 226 and 227 are connected by a bridge member 228. This bridge member may be present, more than one may be present, or there may be no bridge member and the halves are simply connected through the pivotal connection(s), 205 and/or 218. The bridge member, 228 is shown at the upper swingarm pivot, 205, which is one preferable location, but need not be located there.

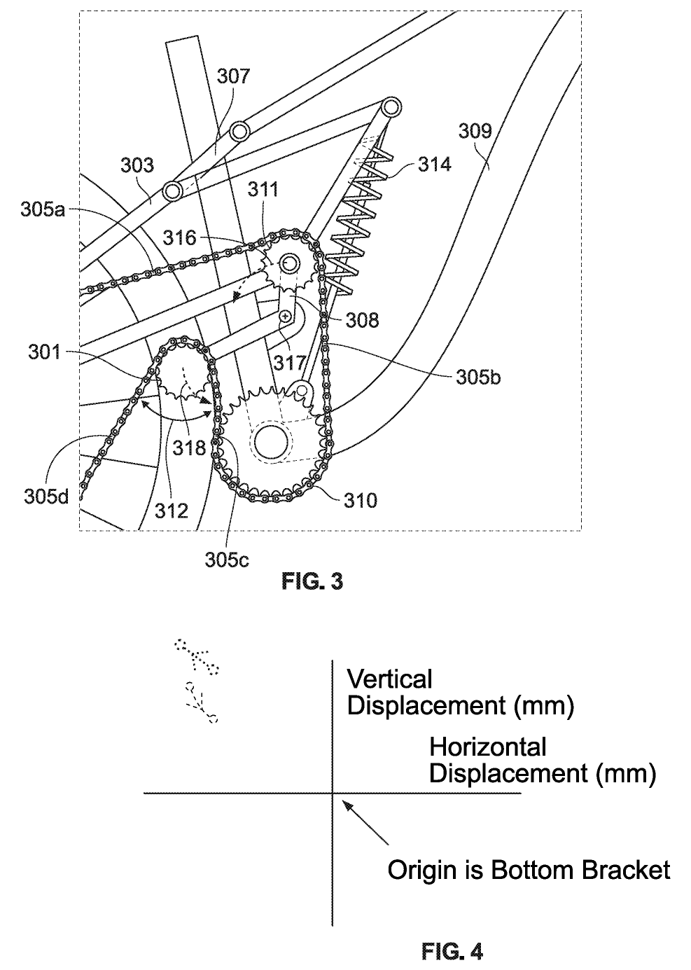

FIG. 3 shows another embodiment that mounts the lower idler 301 on the bottom link 308. As described in FIG. 1A, a swingarm 303 is coupled to a main frame 309 via a top link 307 and a bottom link 308; a chainring 310 receives a chain that includes an upper rear portion or segment 305a, an upper front portion or segment 305b, a lower front portion or segment 305c, and a lower rear portion or segment 305d; and a shock 314 is coupled to the swingarm 303 and the frame 309.

The positioning of the lower idler 301 and the bottom link 308 are done so as to provide a motion path 318 that shortens the lower front portion of the chain 305c in order to cancel the growth of other segments. This configuration is capable of achieving similar amounts of chain growth as that in FIG. 1B. Likewise, other embodiments exist that mount the lower idler on another moveable member in order to achieve chain growth reduction via shortening a portion of the chain. The other elements are as they are in FIG. 1B. The motion path 316 of the upper idler 311 is similar to that described in FIGS. 1 and 2. The lower idler 318 center to chainring 310 center distance will preferably get shorter by between 0 and 200 mm, more preferably 10 and 150 mm, and most preferably 20 and 90 mm as the suspension compresses.

FIG. 4 shows a graph of the motion paths of the lower idlers of the embodiments in FIG. 1B (dotted arrow) and FIG. 3 (dashed arrow). This shows how a variety of motion paths can achieve the shortening of a portion of chain in order to control overall chain growth and/ or the opening of the ‘v’ to do the same.

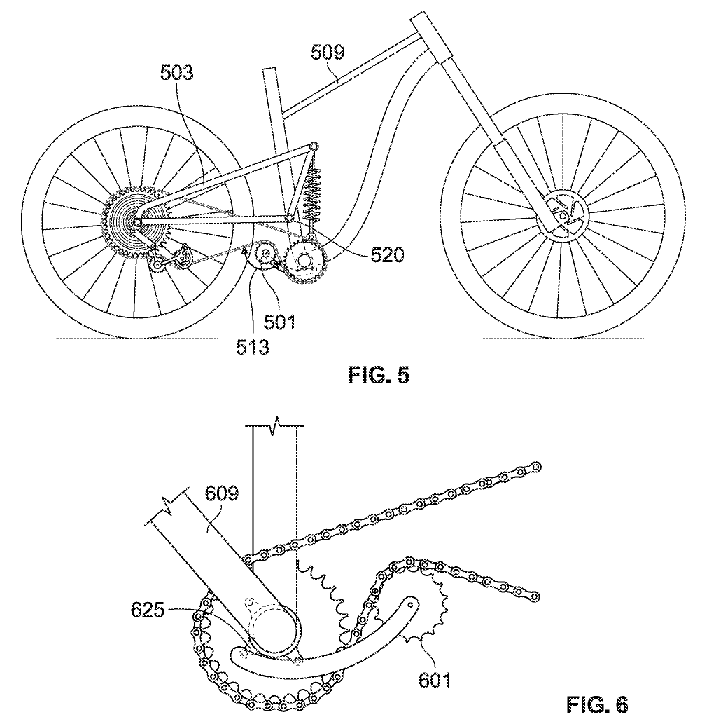

FIG. 5 shows a known bicycle configuration having a single pivot linkage where the swingarm 503 is directly pivotally connected to the front main frame 509 at the swingarm pivot 520. Here, the chain wrap angle 513 of the lower idler 501 may still change as the bike compresses, but the lower idler 501 will not move relative to the main frame, thus limiting the opening of the chain wrap angle and limiting the degree of chain growth cancellation possible.

FIG. 6 shows a known solution of mounting the lower idler 601 to the ISCG tabs 625 attached to the bottom bracket of the front main frame 609. Note this view is from the left side of the bicycle, while most here are from the right side. This solution has no motion path of the idler, and thus limits the chain growth values achievable. This type of lower idler mounting results in no motion relative to the front main frame.

While the drivetrain of the present disclosure has been described as using a chain and rear derailleur, it may also use other types. The chain may be replaced by a belt, the rear derailleur may be replaced by a chain tensioner (on swingarm, main frame, or any other linkage members), and/ or gearbox (on swingarm, main frame, or any other linkage members). Similarly, it may use a single speed set up and/or any other type of convenient drivetrain.

Also disclosed herein are methods of making the bicycle drivetrain management and rear suspension systems. A method, comprising: providing a bicycle main frame and a swingarm; forming a dual-link suspension system including a top link and a bottom link; coupling the top link to the swingarm and the main frame; coupling the bottom link to the swingarm and the main frame.

The method further includes coupling an upper idler system to the main frame and the swingarm. In some embodiments, the method further includes coupling a lower idler system to the swingarm. In other embodiments, the method further includes coupling the lower idler system to the bottom link, providing at least one idler configured to guide a drive element; and mounting the at least one idler to at least one of the main frame portion, the rear frame portion, or the suspension linkage.

This disclosure has been described in relation to bicycles having a rear suspension linkage and a front suspension fork, but other vehicles such as dirt bikes, electric bicycles, and motorcycles could also benefit in a similar way.

Those specifications described above are the embodiments to exemplify the present disclosure to enable the person skilled in the art to understand, make, and use embodiments of the present disclosure. This description, however, is not intended to limit the scope of the present disclosure. Any equivalent modification and variation according to the spirit of the present disclosure is to be also included within the scope of the claims stated below.

The components, steps, features, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, features, benefits and advantages. These also include embodiments in which the components are arranged differently, particularly the structural frame members.

The scope of protection is limited solely by the claims. That scope is intended and should be interpreted to be as broad as is consistent with the ordinary meaning of the language that is used in the claims when interpreted in light of this specification and the prosecution history that follows and to encompass all structural and functional equivalents.

1. A device, comprising:
a linkage system, including:
a lower idler configured to be mounted on any member of a non-single pivot linkage that is not a front main frame, wherein a single pivot has only two rigid bodies that are part of the linkage, so that a rear axle path is a portion of a circle.

2. The device of claim 1, further including a motion path of the lower idler that limits total chain growth to a degree ranging from -40 mm to 30mm.

3. The device of claim 2, wherein the degree ranges from -30 mm to 20mm.

4. The device of claim 3, wherein the degree ranges from -20mm to 10mm.

5. The device of claim 1, wherein linkage system is configured to receive a chain, and wherein the lower idler has a motion path that limits total chain growth by reducing a chain wrap angle on the lower idler while in a smallest rear cog by an amount from more than 10 degrees.

6. The device of claim 5, wherein the amount is more than 20 degrees.

7. The device of claim 6, wherein the amount is more than 30 degrees.

8. The device of claim 1, wherein the linkage system further includes:
a moveable swingarm configured to be coupled to a main frame, wherein the lower idler is moveable relative to the main frame as the suspension compresses and coupled to the swingarm; and
an upper idler configured to be fixed to a swingarm of a bicycle, the upper and lower idlers are configured to receive a chain.

9. A device, comprising:
a linkage for a bicycle, including an upper idler configured to receive a chain of the bicycle, the linkage configured to control a distance between a center of the upper idler and a center of a chainring, the change in this distance ranging from plus 100 mm and minus 100 mm.

10. The device of claim 9 wherein the change in distance is plus 50 mm and minus 50 mm.

11. The device of claim 9, wherein the change in distance is plus 20 mm and minus 30 mm.

12. A device, comprising:
a bicycle, including:
a main frame having an upper main frame pivot and a lower main frame pivot;
a swingarm having an upper swingarm pivot and a lower swingarm pivot; and
a dual link suspension system coupling the main frame to the swingarm, wherein the upper main frame pivot is above and in front of the upper swingarm pivot, and wherein the lower swingarm pivot is above the lower main frame pivot.

13. The device of claim 12, wherein the lower swingarm pivot is in front of the upper swingarm pivot.

14. The device of claim 12, further including a shock attached between the swingarm and main frame.

15. The device of claim 12, further including a rear axle path that has some component of backward travel throughout its compression stroke.

16. The device of claim 12, further including an upper idler pulley.

17. The device of claim 16, wherein the upper idler pulley is coupled to the swingarm.

18. The device of claim 16, wherein dual link suspension system includes an upper link and a lower link, the upper link coupling the swingarm via the upper swingarm pivot to the main frame via the upper main frame pivot, the lower link coupling the swingarm via the lower swingarm pivot to the main frame via the lower main frame pivot, and wherein the

19. The device of claim 18, wherein the upper idler pulley is coupled to the lower link.

20. The device of claim 16, further including a rear axle, wherein the upper idler pulley is coupled below an instant center of rotation of the rear axle.
